(19) United States
(12) Patent Application Publication
(10) Pub. No.: US 2012/0287278 A1
(43) Pub. Date: Nov. 15, 2012

(54) Traffic Violation Photo Enforcement System

(76) Inventor: Robert Danis, Manchester, MO (US)

(21) Appl. No.: 13/107,933

(22) Filed: May 15, 2011

(51) Int. Cl. H04N 7/18

(52) U.S. Cl. 348/148; 348/E07.085

(57) ABSTRACT

A portable, transportable or fixed Traffic Violation Photo Enforcement System, (TVPES) operating from either a moving or stationary position, capable of providing complete identification and documentation of multiple moving traffic violations across all lanes of moving traffic and transmitting or relaying the data to a specified law enforcement agency or their approved violation processing service to support municipal, county, and state traffic violation enforcement efforts through the use of constitutionally sufficient evidence for citation generating and later court prosecution. The (TVPES) consists of various off the shelf and customized components including but not limited to one or more of the following: computer based control units, speed detection devices, tracking devices, digital video and single frame cameras, facial recognition software/automated license-plate recognition software capable of analyzing digital video and single-frame imagery, voice recording devices, GPS location devices, data collection and storage devices and data transmitting and receiving devices.

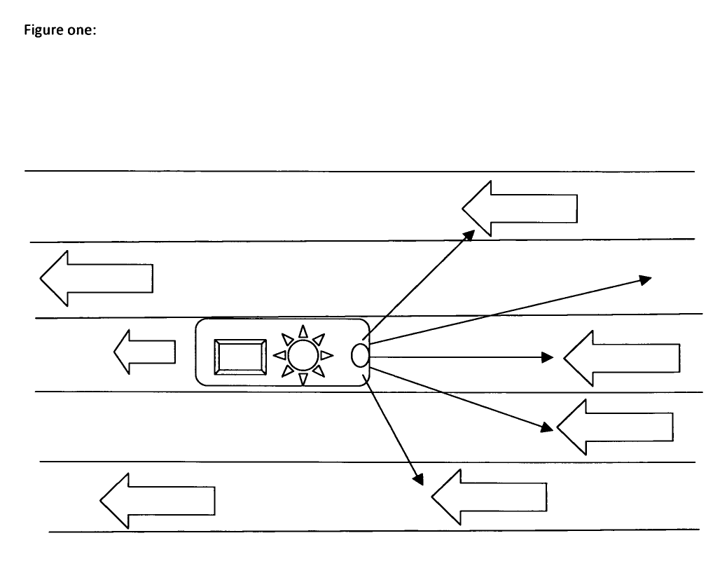

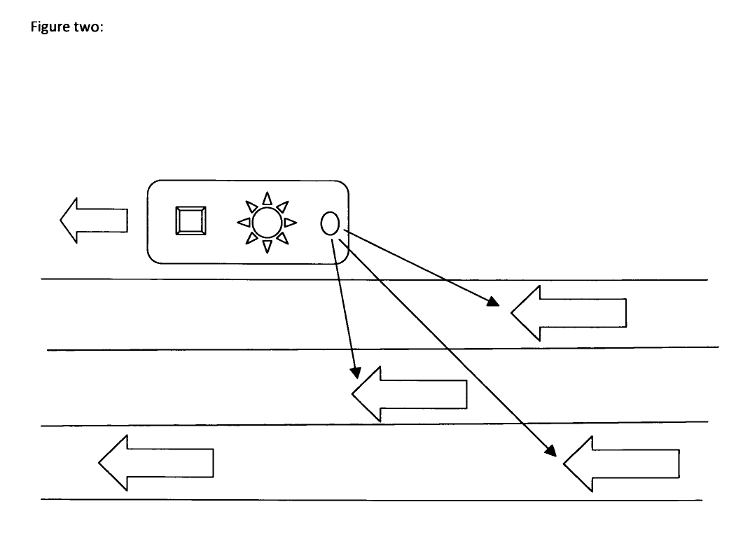

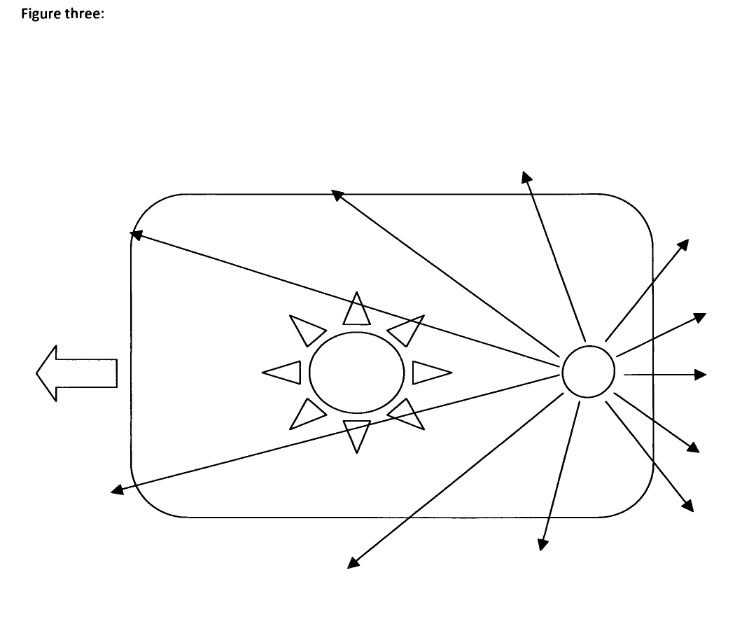

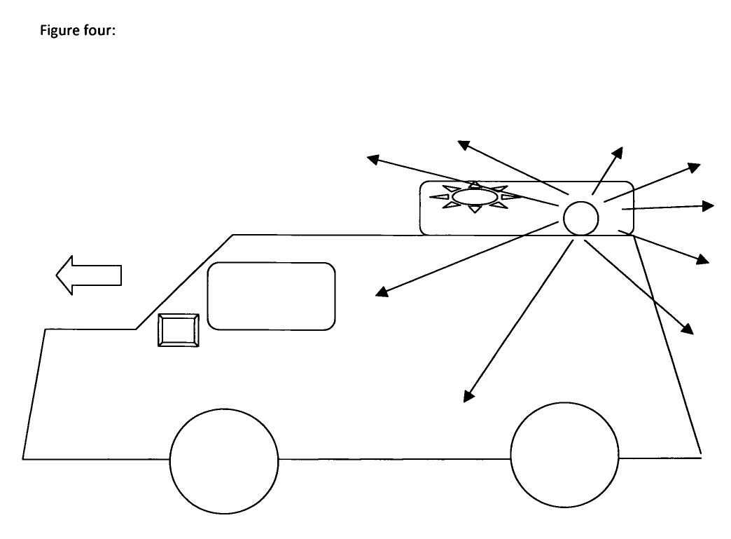

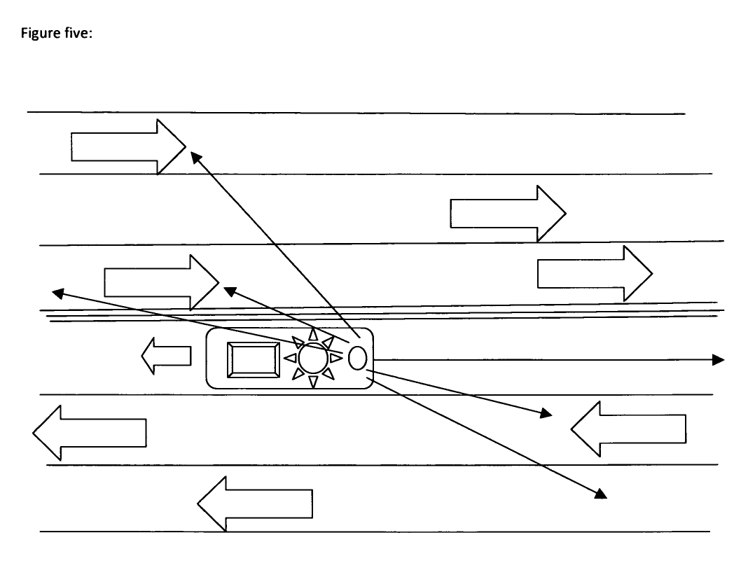

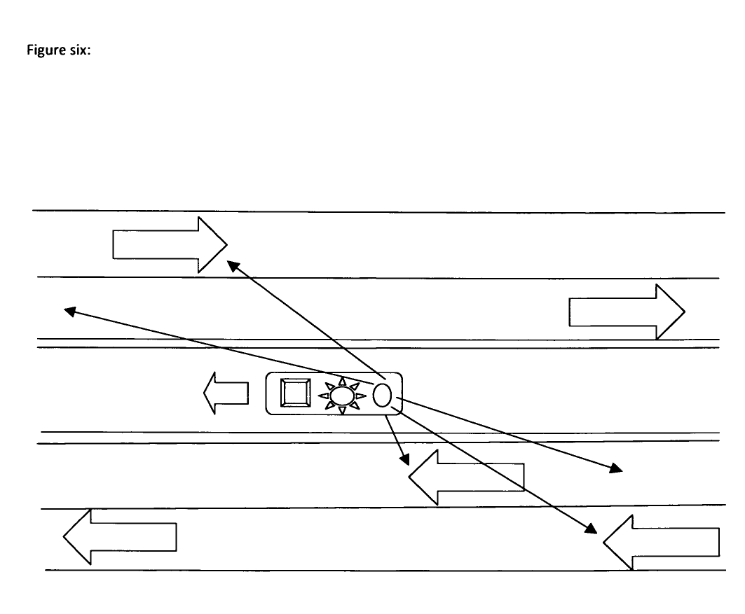

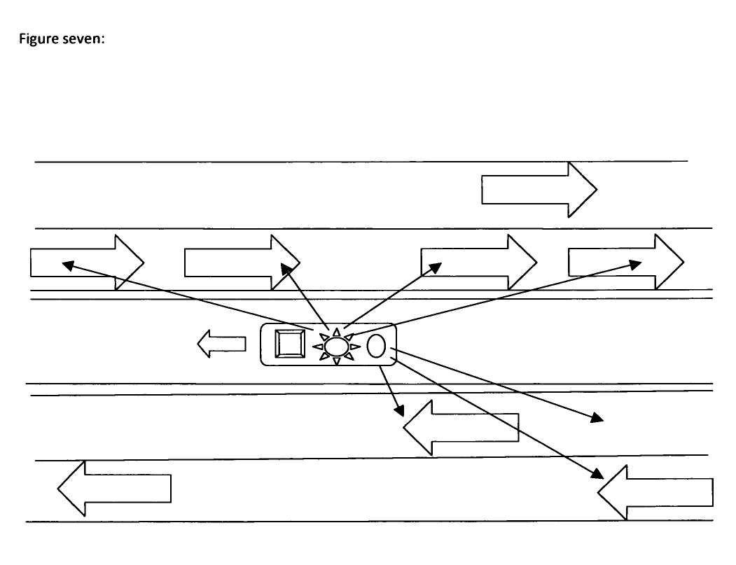

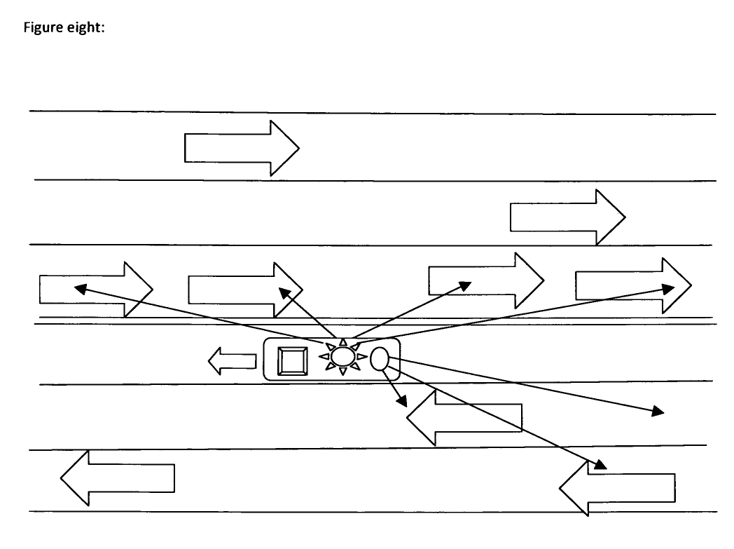

A fully automated, semi automated, or manually operated, portable, transportable, or fixed, traffic violation photo enforcement system (TVPES) interfacing with a computer based control unit and/or drivers manual input, controlling all aspects of the operation of the (TVPES), thereby providing multi-lane coverage for detecting, tracking, identifying, (driver, vehicle, and license plate) determining GPS location, and documenting all types of traffic violations, storing the documentary evidence in an easily retrievable format, including images, (both moving and still), complete violation documentation, facial recognition analysis of the driver and license plate identification of the vehicle for evidentiary purposes with any audio files generated, and thereafter transmitting the documentation and other data to a Processing Center by direct link via Air Card, transmitter, land line, or similar connection either in real time or accumulated for easy retrieval and transmittal at a later date and time. The system could be assembled on a rigid semi-rigid, flexible or otherwise suitable weather-tight frame unit (for exterior mounting) capable of absorbing movement, shock, and vibrations typically encountered by a vehicle on interstates and urban or suburban roadways, without degrading any of the documented evidence, and mounted on the interior or exterior of any vehicle. (Support vehicle). This system shall be comprised of but not limited to the following: Speed detection devices, target vehicle tracking devices, image recording cameras (video and still), facial recognition and automated license-plate recognition software, audio voice recording devices, global positioning devices, data and documentation storage facilities, information transmitting devices, all controlled by an integrated computer with composite displays, with keyboard and touch screen inputs to allow for optional driver data entry with no more than typical defensive driving observations of surrounding traffic environmental conditions. Violation data and imagery with embedded contextual data would be integrated with GPS generated source information, resulting in a composite display of both digital moving video with still image capability using high resolution and image stabilization for capture of composite displays for each violation. Digital moving and still frame imagery would be analyzed by facial recognition and license plate recognition software to determine both driver and vehicle identity. A computer based control unit would be utilized to operate the (TVPES) and receive/store violation digital images and all violation documentation, to be used in the prosecution of violations and/or violators, one or more high resolution digital video image cameras and target vehicle detection/tracking devices (e.g. radar or laser) all mounted and monitoring an area across all lanes of moving traffic behind and in front of the support vehicle depending upon law enforcement requirements and protocols. This system will generate continuous digital images of operator identity, vehicle identity, and vehicle license plate data with embedded contextual speed, GPS location and direction to enhance evidentiary quality in support of the citation issuing and prosecutorial process. Said system would operate with or without support vehicle driver input as needed and would operate in either moving or stationary mode. Said system would remain on but inactive to conserve energy until activated either manually by the vehicle driver or automatically, usually but not necessarily by a pre-programmed speeding violation. Once activated all of the (TVPES) devices power up and document all aspects of the target vehicle traffic violations: Speed detection equipment verifies and records the speeding violation. The tracking equipment locks one or more cameras on the target vehicle or vehicles and cameras zoom in and out, pan side to side, or transfers coverage to another camera or cameras, keeping focus on the target vehicle for driver identification, license plate, vehicle recognition, (front and rear) and recording additional driving violations such as careless and reckless operation of a motor vehicle, excessive lane changes, inattentive driving and so on, as the target vehicle approaches or moves away from the support vehicle, continuously recording and storing the data in the computer control unit data documentation and storage device. Audio recording devices would be used as needed by the support vehicle driver to document his or her eye witness accounts of the violations. GPS devices continuously providing support vehicle and target vehicle location and accumulate, organize, and summarize violations by law enforcement jurisdiction. The computer based control unit continuously accumulates and stores all target vehicle violation documentation for later transmission or continuous transmitting devices transmit the summarized traffic violations to the specific municipality, city, county or state law enforcement agency or their chosen citation processing center. The Processing Center acts as a data processing site supporting the acquisition of violation images and traffic data for review, analysis, processing and storage with access to vehicle registration data for all fifty states and District of Columbia to facilitate immediate citation processing while maintaining appropriate chain-of-custody and secured handling protocols.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention described herein relates generally to a portable, transportable or fixed, fully automated, semi-automated, or manually-operated, integrated system documenting and processing evidence of highway or other roadway traffic violations, and more specifically to a modular system mounted on or in a support vehicle and constituting the (TVPES). The (TVPES) detects, acquires, tracks, photographs, and documents, suspected highway traffic law violators in either moving or stationary mode and transmits the data developed to a Processing Center where the data is reviewed, analyzed, linked to vehicle registration databases and fed into the violation documentation process, and thereafter to a citation-by-mail system coordinated by either local law enforcement, court personnel, or through a vendor supplied processing facility.

Aggressive and inattentive driving on urban roads and freeways directly contributes to the increase in the number and severity of vehicle crashes that result in fatalities, injury, and property damage. For first responders including police, good Samaritans, EMS crews, and firefighters this means putting their safety and lives at great risk. For Federal and State transportation agencies these incidences create even more safety issues due to crash cleanup, infrastructure damage and repairs. For the general public this means higher insurance premiums, which are directly tied to the frequency of crashes per zip code ratio. Budgetary pressure on local and state governmental units is compelling politicians to seek more cost-effective utilization of tax revenue. The invention herein described allows these governmental units to allocate fewer police assets to routine traffic patrol.

### DESCRIPTION OF BACKGROUND ART

Moving traffic violations, particularly speeding, are a major cause of injury-associated accidents on roads and highways. A common method to catch vehicles exceeding the speed limit is to set up a stationary radar or laser site along a roadway to identify speeders and issue citations. According to this method, a police officer uses a radar or laser gun to determine the speed of an approaching vehicle. If the officer determines that the approaching vehicle is speeding, he pursues and directs the driver to pull over to the side of the road and issues a citation. A similar method is for a police officer to place the radar/laser gun in his police vehicle, use it to detect whether vehicles are speeding and then pursue and pull the vehicle over. Another method is based on aircraft time and distance calculations which are communicated to a ground based pursuit vehicle. Most recently, traffic control systems using cameras have been placed in fixed positions at traffic-lighted intersections to capture vehicle and license plate images of a vehicle running a red light and issue a citation by mail without having to stop the vehicle. On a smaller scale cameras have also been deployed in vans, trailers, and other fixed positions to monitor speeding violations in specific trouble areas such as school and construction zones.

All of these violation enforcement methods in use today have many shortcomings and are dangerous, outdated, inefficient, expensive, open to human errors, and have been shown to have little, if any, impact on altering bad driving behavior. For example: When a vehicle is stopped along the side of a road by a police officer to issue a citation to the driver for a traffic violation, both the officer and the occupants of the stopped vehicle are at risk of being hit by other passing vehicles. When a police officer pursues a speeding vehicle in what has become known as a “high speed chase,” the officer's vehicle and the fleeing vehicle pose a serious danger to other travelers on the road. The use of camera traffic control systems requires legislation that specifically sanctions the practice of issuing a citation to a vehicle owner based on license plate information without identifying the vehicle operator and these citations are frequently contested in court. The location of fixed position camera deployments quickly becomes known and create “slow down and speed up driving” problems, which actually increase the probability of accidents. Similarly large numbers of drivers have purchased counter-measure detectors to alert them of the use of a radar/laser guns, and when alerted, a driver may quickly decelerate creating a danger of collision for vehicles traveling behind the decelerating vehicle. The use of CB radios to warn other drivers of a “speed trap” may have a similar result. The widespread use of such devices also diminishes the overall effectiveness of police use of radar/laser guns to detect speeding violations due to warnings broadcast. Additionally, the use of radar/laser guns place an added burden on the strained resources of a police department because officers must appear in court if a driver elects to contest or otherwise question the validity of a traffic citation. The primary reason for the officer's presence in court is to confirm the identity of the driver and to testify about the facts and circumstances surrounding of the issuance of the particular traffic violation or citation. The use of a discrete moving photo enforcement high resolution-digital imaging system to capture images and provide documentation of a variety of traffic violations provides a far safer, efficient, cost effective, and more productive alternative to the foregoing systems and methods currently in use. Such an imaging system is capable of taking digital images of a vehicle and the operator with sufficient resolution for identification purposes so that citations may be issued without having to pursue and stop the vehicle of a suspected violator. The images and complete violation documentation also serve as compelling evidence that may result in fewer court challenges and should relieve a police officer from court appearances merely to identify the vehicle operator. In addition the (TVPES) system could allow for cross-referencing of violator identity, offenses, wants, and warrants, there by alerting and preparing law enforcement and allowing for coordinated and safer arrests.

Digital imaging and photographic technologies and imaging analysis technologies that are capable of capturing high resolution vehicle images from long distances coupled with a speed detection and verification for traffic monitoring and enforcement systems are known in the prior art. One example of such a system is disclosed in U.S. Pat. No. 7,262,790 to Bakewell, which describes a manned, mobile traffic enforcement platform with manually-aimed violation detection and documentation equipment, utilizing digital video and still imagery, incorporating contextual information as well as data input by the system operator and driver, with numerous off-the-shelf components and a physically integrated composite display. Evidence supporting citation issuance is stored on a hard drive or CD with transfer capability by modem.

U.S. Pat. No. 5,515,042 to Nelson reveals a device that includes a camera for recording still or video images, an audio information recorder, a laser or radar speed detector, and a GPS receiver. The system is mounted to the dashboard of a law enforcement vehicle and is operated to record photo images of the vehicle and the vehicle license plate of a suspected speeder and imprint the vehicle speed, time and GPS-determined location onto the photo, all of which is stored for later evaluation. The operator of the system in the law enforcement vehicle also records his or her observations on the audio recording device of the system. At the end of a shift, the photos and audio recordings are recovered and reviewed to determine whether violations have occurred and citations should be issued. U.S. Pat. No. 5,938,717 to Dunne et al. discloses a traffic control system that automatically captures an image of a vehicle and speed information associated with the vehicle and stores the image and information on a hard disk drive. The system uses a laser gun, either hand-held or stationary mount, to determine whether a vehicle is violating established speeding laws. The hard drive is later connected to a base station computer which is, in turn, connected to a LAN where the information from the hard drive is compared with databases containing data such as vehicle registration information and driver licensing information. The system automatically prints a speeding citation and an envelope for mailing to the most recent registered owner of the vehicle. U.S. Pat. No. 5,734,337 to Kupersmit demonstrates a stationary traffic control method and system for determining the speed of a vehicle by generating two images of a moving vehicle and calculating the vehicle speed by determining the distance traveled by the vehicle and the time interval between the two images. The system is capable of automatically looking up vehicle ownership information through available databases and issuing citations or other violation notices to the registered owner of the vehicle. U.S. Pat. No. 5,948,038 to Daly et al. describes a method for procssing traffic violation citations. The method includes the steps for determining whether a vehicle is violating a traffic law, recording an image of the vehicle committing the violation, recording deployment data corresponding to the violation, matching the vehicle information with vehicle registration information to identify the owner, and issuing a traffic violation citation with an image of the vehicle, and the identity of the registered owner of the vehicle.

It would be beneficial to provide a traffic violation monitoring system and method operable by law enforcement personnel as well as private contractors that captures high resolution digital images of a vehicle operator as well as digital images of the vehicle and vehicle license plate so as to positively identify the operator and vehicle involved in traffic violations, not necessarily limited to speeding. It would also be desirable to provide such a system and method that uses advanced communications and GPS location technology to provide the specific location and comprehensive violation data for transmission to a remote evaluation center for data analysis and issuance of citations. It would also be desirable to provide such a system that collects this information independent of jurisdiction lines, bundle the data by specific jurisdiction, and then transmit that specific bundle to its specific citation processor. Such a system and method should collect all the evidence needed to support a traffic citation against a court challenge with minimal involvement by law enforcement personnel.

### BRIEF SUMMARY OF THE INVENTION

A portable, transportable or fixed Traffic Violation Photo Enforcement System, (TVPES) operating from either a moving or stationary position, capable of providing complete identification and documentation of multiple moving traffic violations across all lanes of moving traffic and transmitting or relaying the data to a specified law enforcement agency or their approved violation processing service to support municipal, county, and state traffic violation enforcement efforts through the use of constitutionally sufficient evidence for citation generating and later court prosecution. The (TVPES) consists of various off the shelf and customized components including but not limited to one or more of the following: computer based control units, speed detection devices, tracking devices, digital video and single frame cameras, facial recognition software/automated license-plate recognition software capable of analyzing digital video and single-frame imagery, voice recording devices, GPS location devices, data collection and storage devices and data transmitting and receiving devices.

### BRIEF DESCRIPTION OF DRAWINGS

Figure One: Figure one shows a top down view of the (TVPES) Traffic Violation Photo Enforcement System and the moving support vehicle platform photo enforcement 360 degree violation detection system monitoring traffic flow and scanning for violations across multiple lanes of traffic from a moving position operating within the traffic flow.

Figure Two: Figure two shows a top down view of the (TVPES) Traffic Violation Photo Enforcement System and the moving platform support vehicle photo enforcement 360 degree violation detection system monitoring traffic flow and scanning for violations across multiple lanes of traffic from a stationary position on the right side of the road. The system can operate from either the right or left side of the road.

Figure Three: Figure three shows a top down view of the (TYPES) Traffic Violation Photo Enforcement System compartment where components could be placed in the fully or partially enclosed, movable, transportable, or fixed unit in or on the support vehicle or any moving/stationary platform.

Figure Four: Figure four shows a side view of the (TYPES) Traffic Violation Photo Enforcement System unit mounted on the roof of the support vehicle. The (TVPES) could just as easily be mounted inside the support vehicle.

Figure Five: Figure five shows a top down view of the (TYPES) Traffic Violation Photo Enforcement System and the moving support vehicle platform photo enforcement 360 degree violation detection, tracking, documentation, and communication system monitoring traffic flow and scanning for violations across multiple lanes of traffic in front of and behind the support vehicle from a moving position in the traffic flow.

Figure Six: Figure six shows a top down view of the (TVPES) Traffic Violation Photo Enforcement System and the moving platform support vehicle photo enforcement 360 degree violation detection system monitoring traffic flow and scanning for violations

Figure Seven: Figure seven shows a top down view of the (TVPES) Traffic Violation Photo Enforcement System and the moving platform support vehicle photo enforcement 360 degree violation detection system monitoring traffic both oncoming and from behind, across multiple lanes of traffic from a stationary position in the median. The (TVPES) has detected a violation, usually speeding, and the (TVPES) has isolated the vehicle and is tracking its movement, to record all required documentation for the initial speeding and any additional subsequent violations while its speed detection devices continuing to monitor the traffic flow.

Figure Eight: Figure eight shows a top down view of the (TVPES) Traffic Violation Photo Enforcement System and the moving platform support vehicle photo enforcement 360 degree violation detection system monitoring traffic both oncoming and from behind, across multiple lanes of traffic from a moving position within the flow of traffic. The (TVPES) has detected a violation usually speeding and the (TVPES) has isolated the vehicle and is tracking its movement to record all required documentation for the initial speeding and any subsequent violations while its speed detection devices continuing to monitor the traffic flow.

### DETAILED DESCRIPTION OF THE INVENTION

A fully automated, semi automated, or manually operated, portable, transportable, or fixed, traffic violation photo enforcement system (TVPES) interfacing with a computer based control unit and/or drivers manual input, controlling all aspects of the operation of the (TVPES), thereby providing multi-lane coverage for detecting, tracking, identifying, (driver, vehicle, and license plate) determining GPS location, and documenting all types of traffic violations, storing the documentary evidence in an easily retrievable format, including images, (both moving and still), complete violation documentation, facial recognition analysis of the driver and license plate identification of the vehicle for evidentiary purposes with any audio files generated, and thereafter transmitting the documentation and other data to a Processing Center by direct link via Air Card, transmitter, land line, or similar connection either in real time or accumulated for easy retrieval and transmittal at a later date and time. The system could be assembled on a rigid semi-rigid, flexible or otherwise suitable weather-tight frame unit (for exterior mounting) capable of absorbing movement, shock, and vibrations typically encountered by a vehicle on interstates and urban or suburban roadways, without degrading any of the documented evidence, and mounted on the interior or exterior of any vehicle. (Support vehicle). This system shall be comprised of but not limited to the following: Speed detection devices, target vehicle tracking devices, image recording cameras (video and still), facial recognition and automated license-plate recognition software, audio voice recording devices, global positioning devices, data and documentation storage facilities, information transmitting devices, all controlled by an integrated computer with composite displays, with keyboard and touch screen inputs to allow for optional driver data entry with no more than typical defensive driving observations of surrounding traffic environmental conditions. Violation data and imagery with embedded contextual data would be integrated with GPS generated source information, resulting in a composite display of both digital moving video with still image capability using high resolution and image stabilization for capture of composite displays for each violation. Digital moving and still frame imagery would be analyzed by facial recognition and license plate recognition software to determine both driver and vehicle identity. A computer based control unit would be utilized to operate the (TVPES) and receive/store violation digital images and all violation documentation, to be used in the prosecution of violations and/or violators, one or more high resolution digital video image cameras and target vehicle detection/tracking devices (e.g. radar or laser) all mounted and monitoring an area across all lanes of moving traffic behind and in front of the support vehicle depending upon law enforcement requirements and protocols. This system will generate continuous digital images of operator identity, vehicle identity, and vehicle license plate data with embedded contextual speed, GPS location and direction to enhance evidentiary quality in support of the citation issuing and prosecutorial process. Said system would operate with or without support vehicle driver input as needed and would operate in either moving or stationary mode. Said system would remain on but inactive to conserve energy until activated either manually by the vehicle driver or automatically, usually but not necessarily by a pre-programmed speeding violation. Once activated all of the (TVPES) devices power up and document all aspects of the target vehicle traffic violations: Speed detection equipment verifies and records the speeding violation. The tracking equipment locks one or more cameras on the target vehicle or vehicles and cameras zoom in and out, pan side to side, or transfers coverage to another camera or cameras, keeping focus on the target vehicle for driver identification, license plate, vehicle recognition, (front and rear) and recording additional driving violations such as careless and reckless operation of a motor vehicle, excessive lane changes, inattentive driving and so on, as the target vehicle approaches or moves away from the support vehicle, continuously recording and storing the data in the computer control unit data documentation and storage device. Audio recording devices would be used as needed by the support vehicle driver to document his or her eye witness accounts of the violations. GPS devices continuously providing support vehicle and target vehicle location and accumulate, organize, and summarize violations by law enforcement jurisdiction. The computer based control unit continuously accumulates and stores all target vehicle violation documentation for later transmission or continuous transmitting devices transmit the summarized traffic violations to the specific municipality, city, county or state law enforcement agency or their chosen citation processing center. The Processing Center acts as a data processing site supporting the acquisition of violation images and traffic data for review, analysis, processing and storage with access to vehicle registration data for all fifty states and District of Columbia to facilitate immediate citation processing while maintaining appropriate chain-of-custody and secured handling protocols.

What I claim as my invention is:

1. A fully automated, semi automated, or manually operated, portable, transportable, or fixed, traffic violation photo enforcement system (TVPES) interfacing with a computer based control unit and/or drivers manual input, controlling all aspects of the operation of the (TVPES), thereby providing multi-lane coverage for detecting, tracking, identifying, (driver, vehicle, and license plate) determining GPS location, and documenting all types of traffic violations, storing the documentary evidence in an easily retrievable format, including images, (both moving and still), complete violation documentation, facial recognition analysis of the driver and license plate identification of the vehicle for evidentiary purposes with any audio files generated, and thereafter transmitting the documentation and other data to a Processing Center by direct link via Air Card, transmitter, land line, or similar connection either in real time or accumulated for easy retrieval and transmittal at a later date and time. The system could be assembled on a rigid semi-rigid, flexible or otherwise suitable weather-tight frame unit (for exterior mounting) capable of absorbing movement, shock, and vibrations typically encountered by a vehicle on interstates and urban or suburban roadways, without degrading any of the documented evidence, and mounted on the interior or exterior of any vehicle. (Support vehicle). This system shall be comprised of but not limited to the following: Speed detection devices, target vehicle tracking devices, image recording cameras (video and still), facial recognition and automated license-plate recognition software, audio voice recording devices, global positioning devices, data and documentation storage facilities, information transmitting devices, all controlled by an integrated computer with composite displays, with keyboard and touch screen inputs to allow for optional driver data entry with no more than typical defensive driving observations of surrounding traffic environmental conditions. Violation data and imagery with embedded contextual data would be integrated with GPS generated source information, resulting in a composite display of both digital moving video with still image capability using high resolution and image stabilization for capture of composite displays for each violation. Digital moving and still frame imagery would be analyzed by facial recognition and license plate recognition software to determine both driver and vehicle identity. A computer based control unit would be utilized to operate the (TVPES) and receive/store violation digital images and all violation documentation, to be used in the prosecution of violations and/or violators, one or more high resolution digital video image cameras and target vehicle detection/tracking devices (e.g. radar or laser) all mounted and monitoring an area across all lanes of moving traffic behind and in front of the support vehicle depending upon law enforcement requirements and protocols. This system will generate continuous digital images of operator identity, vehicle identity, and vehicle license plate data with embedded contextual speed, GPS location and direction to enhance evidentiary quality in support of the citation issuing and prosecutorial process. Said system would operate with or without support vehicle driver input as needed and would operate in either moving or stationary mode. Said system would remain on but inactive to conserve energy until activated either manually by the vehicle driver or automatically, usually but not necessarily by a pre-programmed speeding violation. Once activated all of the (TVPES) devices power up and document all aspects of the target vehicle traffic violations: Speed detection equipment verifies and records the speeding violation. The tracking equipment locks one or more cameras on the target vehicle or vehicles and cameras zoom in and out, pan side to side, or transfers coverage to another camera or cameras, keeping focus on the target vehicle for driver identification, license plate, vehicle recognition, (front and rear) and recording additional driving violations such as careless and reckless operation of a motor vehicle, excessive lane changes, inattentive driving and so on, as the target vehicle approaches or moves away from the support vehicle, continuously recording and storing the data in the computer control unit data documentation and storage device. Audio recording devices would be used as needed by the support vehicle driver to document his or her eye-witness accounts of the violations. GPS devices continuously providing support vehicle and target vehicle location and accumulate, organize, and summarize violations by law enforcement jurisdiction. The computer based control unit continuously accumulates and stores all target vehicle violation documentation for later transmission or continuous transmitting devices transmit the summarized traffic violations to the specific municipality, city, county or state law enforcement agency or their chosen citation processing center. The Processing Center acts as a data processing site supporting the acquisition of violation images and traffic data for review, analysis, processing and storage with access to vehicle registration data for all fifty states and District of Columbia to facilitate immediate citation processing while maintaining appropriate chain-of-custody and secured handling protocols.
